(19) United States
(12) Patent Application Publication
(10) Pub. No.: US 2012/0308772 A1
(43) Pub. Date: Dec. 6, 2012

(54) STEAM TURBINE MEMBER

(75) Inventors: Hiroshi Haruyama, Hitachi (JP); Masahiko Arai, Hitachinaka (JP); Hiroyuki Doi, Tokai (JP); Takeshi Izumi, Hitachi (JP)

(73) Assignee: HITACHI, LTD., Tokyo (JP)

(21) Appl. No.: 13/577,757

(22) PCT Filed: Feb. 17, 2011
(86) PCT No.: PCT/JP2011/053323

§ 371 Date: Aug. 8, 2012

(30) Foreign Application Priority Data
Mar. 12, 2010 (JP) 2010-055228

(51) Int. Cl. B32B 15/04; F01D 5/28

(52) U.S. Cl. 428/141; 428/701; 428/697; 428/336

(57) ABSTRACT

An object is to provide a steam turbine member having excellent oxidation resistance at low cost without using an alloy coating such as a thermally sprayed or sintered body. The steam turbine member includes a substrate made of stainless steel containing Fe as a main component, 8 to 15 wt % of Cr, and 0.1 to 1.0 wt % of Mn. The steam turbine member has, on a surface of the substrate, an oxide film made of an oxide of a constituent element of the substrate. It is preferable that the oxide film thickness is 1 μm or less. It is also preferable that the oxide film has a surface roughness Ra of 1.6 a or less.

### TECHNICAL FIELD

The present invention relates to a steam turbine member having a protective oxide film on the surface thereof.

### BACKGROUND ART

In recent years, steam turbines are required to have high electricity generation efficiency, and the steam temperature tends to rise. In the case where the steam temperature is 566° C. to 630° C., generally, a 9 to 12% Cr-based stainless steel is used as a steam turbine member. As a steam turbine member, for example, a steam governor valve is configured such that a valve stem and a sleeve slide relative to a bushing and a valve body, respectively, to control the vapor flow rate.

A nitriding treatment has been performed for the purpose of improving wear resistance. However, a nitriding treatment does not provide oxidation resistance. Therefore, when the steam governor valve is oxidized by high-temperature steam, the gap at the sliding portion is reduced due to oxide scale formed with operation time, causing a problem in that the sliding portion is fixed unless the scale is removed in every regular inspection. In addition, in a main steam pipe or a reheating steam pipe, there is a problem in that the formed oxide scale grows and falls off.

As a method for improving the oxidation resistance of these steam turbine members, generally, an alloy coating, ceramic, or the like is formed on the substrate surface by thermal spraying or sintering or by welding.

For example, PTL 1 describes a method in which fine metal particles for forming an alloy are applied and sintered to form a metal particle composition containing an organic medium on the steel surface. PTL 2 describes a method in which a nano-structured coating having improved wear resistance and erosion resistance is produced using a corrosion-resistant binder matrix.

In the case where an alloy coating is formed by thermal spraying or sintering, although excellent oxidation resistance and wear resistance are achieved, there is a possibility of peeling, resulting in a problem of increased cost. In the case where an alloy coating is formed by welding, residual stress is generated, whereby cracking may occur. Further, in a member having a sliding portion, gap control is difficult. In addition, as in a nitriding treatment, an improvement in wear resistance may lead to a decrease in oxidation resistance. Meanwhile, when the surface is only polished without forming a film on the surface, such a steam turbine member is oxidized during long-time operation.

As described above, the prior art has not yet been satisfactory in terms of the oxidation resistance of a turbine member and cost.

### CITATION LIST

### Patent Literature

PTL 1: JP-A-2002-309303

PTL 2: JP-T-2007-507604

### SUMMARY OF THE INVENTION

### Technical Problem

An object of the inveniton is to provide a steam turbine member having excellent oxidation resistance at low cost without using an alloy coating such as a thermally sprayed or sintered body.

### Solution to Problem

The steam turbine member of the invention includes a substrate made of a stainless steel containing Fe as a main component, 8 to 15 wt % of Cr, and 0.1 to 1.0 wt % of Mn. The steam turbine member is characterized by having, on a surface of the substrate, an oxide film made of an oxide of a constituent element of the substrate.

### Advantageous Effects of Invention

According to the invention, a steam turbine member having excellent oxidation resistance can be provided at low cost.

Further objects, features, and advantages of the invention will become apparent from the following description of embodiments of the invention with reference to the accompanying drawings.

### BRIEF DESCRIPTION OF THE DRAWINGS

FIG. 1 is a cross-sectional view of a high- and medium-pressure integral steam turbine according to the invention.

FIG. 2 is a cross-sectional view of a steam governor valve according to the invention.

FIG. 3 shows relative values of gap distance in the examples of the invention.

### DESCRIPTION OF EMBODIMENTS

The steam turbine member of the invention includes a substrate made of a stainless steel containing 0.1 to 1.0 wt % of Mn and 8 to 15 wt % of Cr and has a protective oxide film containing Cr, Mn, and Fe on the surface thereof. The oxide film has a thickness of 1 μm or less.

In addition, in the steam turbine member, further, the surface roughness Ra is 1.6 a or less.

The present inventors focused their attention to the film thickness and surface roughness of a steam turbine member and studied the formation of oxide scale and the properties of the surface. As a result, they found that a steam turbine member that includes a substrate made of a Cr stainless steel containing 0.1 to 1.0 wt % of Mn and 8 to 15 wt % of Cr and has a protective oxide film containing Cr, Mn, and Fe on the surface thereof, the oxide film having a thickness of 1 μm or less, has excellent oxidation resistance.

With respect to the 8 to 15% Cr stainless steel as a substrate, usually, when the stainless steel is oxidized in air, Fe and Cr are oxidized to form FeCr₂O₄ scale. This scale is less protective than a chromia Cr₂O₃ film and thus cannot suppress oxidation. Thus, after long-time operation, magnetite Fe₃O₄ scale is formed on the outer layer of the FeCr₂O₄ scale. In the case where the 8 to 15% Cr stainless steel is oxidized in a low-oxygen partial pressure environment, because the standard free energy of oxide formation of Cr is lower than that of Fe, Cr is preferentially oxidized, but the amount of Cr is insufficient to uniformly form a protective chromia Cr₂O₃ film. However, it was found that in the case where a 9 to 13% Cr stainless steel containing 0.1 to 1.0% of Mn is oxidized in a low-oxygen partial pressure environment, because the standard free energy of formation of Mn oxides is still lower than that of Fe and Cr, an Mn oxide is produced in the form of nodules, while Cr-rich oxides are formed in the remaining part, whereby oxidation during long-time operation is suppressed.

With respect to surface roughness, the surface is roughened with the growth of oxides on the surface, and it is thus preferable that no oxide is formed. However, in a 8 to 15% Cr steel, as a method other than the application of a coating of an alloy, ceramic, or the like, it is important to suppress the growth of oxides. The present inventors found that when the thickness of the protective oxide film is 1 μm or less, the growth of oxide scale is significantly suppressed. As a result of various studies, in order to maintain oxidation resistance even after long-time operation, it is important that the protective oxide film has a thickness of 1 μm or less and a surface roughness Ra of 1.6 a or less; the invention was thus accomplished.

Hereinafter, the invention will be described in detail using the drawings.

First, a steam turbine using the invention will be described.

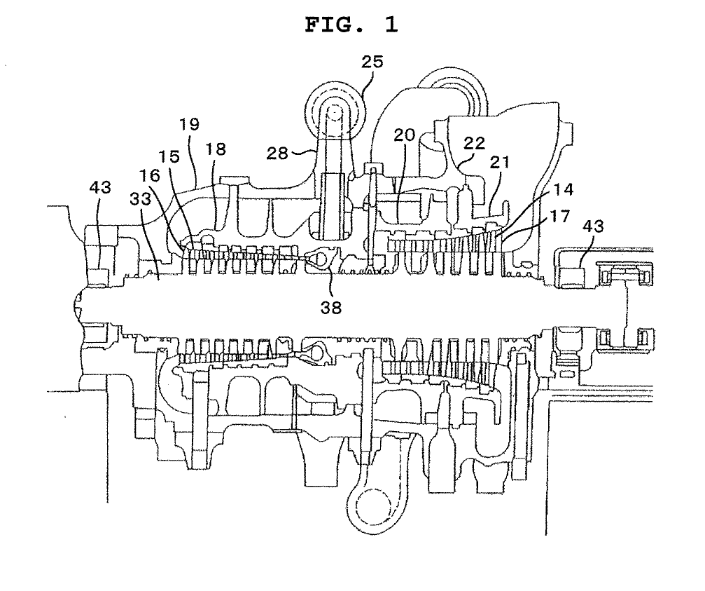

FIG. 1 shows an example of a steam turbine plant equipped with a steam turbine member of the invention. The steam turbine member to which the invention is applied is, for example, a main steam pipe 28, a steam governor valve (described later), a medium-pressure stator blade, a high-pressure stator blade, a high-pressure rotor blade, a medium-pressure rotor blade, or the like. However, without limitation thereto, the invention is applicable to any steam turbine member. In FIG. 1, 14 is a medium-pressure stator blade, 15 is a high-pressure stator blade, 16 is a high-pressure rotor blade, 17 is a medium-pressure rotor blade, 18 is a high-pressure inner casing, 19 is a high-pressure outer casing, 20 and 21 are each a medium-pressure inner casing, 22 is a medium-pressure outer casing, 25 is a flange or an elbow, 28 is a main steam inlet (pipe), 33 is a high- and medium-pressure rotor shaft, 38 is a nozzle box, and 43 is a bearing.

Steam at 566° C. supplied from a boiler is guided, through the main steam pipe 28 and the nozzle box 38, to the high-pressure inner casing 18 and then to the high-pressure outer casing 19. During that time, the high-pressure stator blade 15 changes the direction of the steam flow and also increases the speed of the steam utilizing the pressure difference, while the high-pressure rotor blade 16 converts the steam energy into rotational energy and rotates the rotor 33 to generate electricity in a generator connected to the rotor 33.

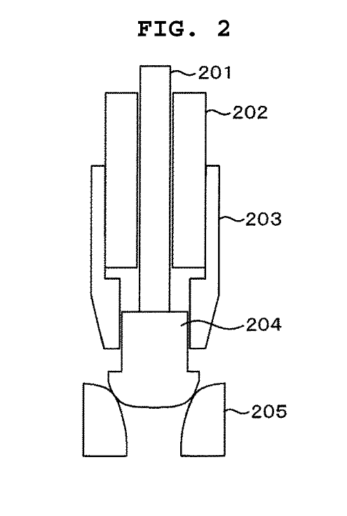

FIG. 2 is a cross-sectional view schematically showing an example of the steam governor valve.

The steam governor valve includes a valve stem 201, a bushing 202, a sleeve 203, a valve body 204, and a valve seat 205. The valve stem slides relative to the bushing, and the valve body slides relative to the sleeve. A forging material was machined, then surface-polished to a surface roughness Ra of 0.4 a for formation, and subsequently heat-treated at 650° C. for 4 hours for production. In the case where the turbine member has a welding portion, the oxide film of the invention is formed on the surface of the turbine member by a heat treatment after welding. This eliminates the need of removing oxide scale by blasting, polishing, or the like after welding and also of the subsequent washing step, which have been heretofore necessary in the case of production by polishing to a surface roughness Ra of 1.6 a.

The oxide film of the invention is formed on the surface of the turbine member. The oxide film is made of an oxide of a constituent element of the substrate, and the oxide film thickness is 1 μm or less.

The surface roughness Ra of the oxide film is 1.6 a or less, preferably 1.0 a or less, and particularly preferably 0.5 a or less. As surface roughness, maximum height Ry, ten-point average roughness Rz, arithmetic average roughness Ra, or the like is used depending on the calculation method. Average roughness in the invention is arithmetic average roughness Ra, which is obtained by sampling a reference length from a roughness curve in the direction of its mean line, summing the absolute values of deviations from the mean line to the roughness curve in the sampled portion, and averaging the sum in micrometers.

The components of the oxide film mainly include Cr, Fe, O, and Mn. Further, of these components, components other than O come from the substrate and are not given from the outside.

When the steam turbine member has the oxide film of the invention, the formation of oxide scale during operation can be suppressed. In addition, the steam turbine member having excellent oxidation resistance can be provided at low cost.

With respect to the heat treatment atmosphere, although the effect can also be seen when the heat treatment is performed in air, it is preferably performed in an inert gas atmosphere such as Ar or in a low-oxygen partial pressure. In particular, an atmosphere of 1×10⁻¹² atm or less is preferable. With respect to the heat treatment temperature, it is performed at a temperature equal to or higher than the actual operating temperature. In the case of a blade having a welding structure, the temperature is preferably the temperature of stress-relief annealing after welding during production. In the case of a blade having no welding structure, the temperature is preferably equal to or lower than the blade material tempering temperature. In particular, a temperature of 650 to 690° C. is preferable. With respect to the heat treatment time, when it is performed in a low-oxygen atmosphere for a longer period of time, a more protective Cr-rich oxide film is formed. However, practically, considering the process, a short period of time is preferable. In particular, a time of 3 to 12 hours is preferable.

Hereinafter, the reasons for the restriction on the components of the steam turbine member used in the invention will be described.

Cr improves corrosion resistance and oxidation resistance in steam. In addition, it improves hardenability and is also effective in improving toughness and strength. When the amount is less than 8.0%, these effects are insufficient, while an excessive addition of more than 15.0% leads to the formation of a δ-ferrite phase, reducing creep rupture strength and toughness.

In particular, a range of 9.0 to 13.0 is preferable.

Mn is 0.1% or more in order to form an Mn oxide on a nodule. Meanwhile, the amount is 1.0% or less because the addition of a large amount is likely to cause creep embrittlement. In particular, a range of 0.5 to 1.0% is preferable.

Other elements that can be contained include C, Si, Ni, Mo, V, W, Nb, N, Cu, Al, inevitable impurities S and P, etc., and it is preferable that none of the elements impair oxidation resistance or strength.

### Example 1

Table 1 shows the chemical composition of the stainless steel used for a steam turbine member in this example.

TABLE 1

| C | Si | Mn | Ni | Cr | Mo | V | W | Fe |
|---|---|---|---|---|---|---|---|---|
| 0.25 | 0.30 | 0.70 | 0.7 | 12.0 | 1.10 | 0.25 | 1.10 | Remainder |

An oxidation test was performed using a specimen of the above composition.

A steel ingot treated in a high-frequency melting furnace was hot-forged at a temperature of 850 to 1150° C. into a 30-mm square. Quenching was performed at 1024 to 1052° C. for 1 hour, followed by oil cooling, and tempering was performed at 620° C. or more for 2 hours, followed by air cooling. A specimen measuring 20×20×5 mm was cut from the 30-mm square test material. The surface was polished with #600 emery paper and then degreased with acetone.

Next, a heat treatment was performed in air at 690° C. for 4 hours. The rates of temperature rise and fall are each 100° C. per hour.

After the heat treatment, an oxide film having a thickness of about 0.5 μm was formed on the steel surface.

Using this specimen, a 1000-hour oxidation test was performed in air at a temperature of 650° C., and the thickness of the oxide film was measured under a scanning microscope.

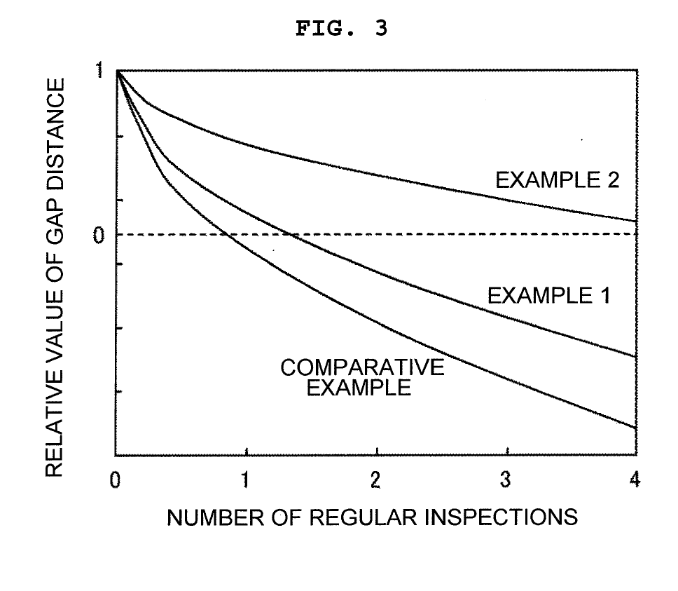

FIG. 3 shows relative values of gap distance estimated using the parabolic law from the film thickness after the heat treatment in air and the subsequent 1000-hour air oxidation test at 650° C. As a comparative example, the specimen shown in Table 1 untreated was subjected to an oxidation test. The results of this test are also shown. As a result, because of the heat treatment in air, the amount of time taken for gap reduction was longer than in the comparative example. It was thus confirmed that oxidation resistance was improved.

### Example 2

The following describes the case where the same specimen as in Example 1 was produced and heat-treated in a low-oxygen partial pressure.

A steel ingot treated in a high-frequency melting furnace was hot-forged at a temperature of 850 to 1150° C. into a 30-mm square. Quenching was performed at 1024 to 1052° C. for 1 hour, followed by oil cooling, and tempering was performed at 620° C. or more for 2 hours, followed by air cooling. A specimen measuring 20×20×5 mm was cut from the 30-mm square test material. The surface was polished with #600 emery paper and then degreased with acetone.

Next, a 4-hour heat treatment was performed at a temperature of 690° C. in a low-oxygen partial pressure at an oxygen partial pressure of 1×10⁻¹² atm or less. The rates of temperature rise and fall are each 100° C. per hour. After the heat treatment in a low-oxygen atmosphere, an oxide film having a thickness of about 0.3 μm was formed on the steel surface.

Using this specimen, a 1000-hour oxidation test was performed in air at a temperature of 650° C., and the thickness of the oxide film formed on the steel surface was measured under a scanning microscope.

FIG. 3 shows relative values of gap distance estimated from the results of this example using the parabolic law.

As a result, because of the heat treatment in low oxygen, the amount of time taken for gap reduction was about four times longer than in the comparative example. It was thus confirmed that oxidation resistance was significantly improved. It was also revealed that the improvement of oxidation resistance by the heat treatment in a low-oxygen atmosphere is more significant than by the heat treatment in air shown in Example 1.

Therefore, the application of the steam turbine member of the invention makes it possible to provide a steam turbine member having excellent oxidation resistance at low cost without using an alloy coating formed by a thermally sprayed or sintered body, welding, or the like.

Although the above description was made with reference to the examples, the invention is not limited thereto. It is obvious to a person skilled in the art that various modifications and amendments can be made within the scope of the spirit of the invention and the accompanying claims.

### REFERENCE SIGNS LIST

14 Medium-pressure stator blade

15 High-pressure stator blade

16 High-pressure rotor blade

17 Medium-pressure rotor blade

18 High-pressure inner casing

19 High-pressure outer casing

20,21 Medium-pressure inner casing

22 Medium-pressure outer casing

25 Flange, elbow

28 Main steam inlet

33 High- and medium-pressure rotor shaft

38 Nozzle box

43 Bearing

201 Valve stem

202 Bushing

203 Sleeve

204 Valve body

205 Valve seat

1. A steam turbine member comprising a substrate made of a stainless steel containing Fe as a main component, 8 to 15 wt % of Cr, and 0.1 to 1.0 wt % of Mn,
the steam turbine member being characterized by having, on a surface of the substrate, an oxide film made of an oxide of a constituent element of the substrate.

2. A steam turbine member according to claim 1, characterized in that the oxide film contains Fe, Cr, and Mn.

3. A steam turbine member according to claim 1, characterized in that the oxide film is 1 μm or less.

4. A steam turbine member according to claim 1, characterized in that the oxide film has a surface roughness Ra of 1.6 a or less.
